(19) United States
(12) Patent Application Publication
(10) Pub. No.: US 2010/0231486 A1
(43) Pub. Date: Sep. 16, 2010

(54) PLASMA ARC TUBE DISPLAY DEVICE

(75) Inventors: Kenji Awamoto, Hyogo (JP); Manabu Ishimoto, Hyogo (JP); Hitoshi Hirakawa, Hyogo (JP); Koji Shinohe, Hyogo (JP); Yosuke Yamazaki, Hyogo (JP)

Correspondence Address: STITES & HARBISON PLLC, 401 COMMERCE STREET, SUITE 800, NASHVILLE, TN, 37219, US

(73) Assignee: SHINODA PLASAMA CORPORATION, Kobe-shi, Hyogo (JP)

(21) Appl. No.: 12/282,103

(22) PCT Filed: Mar. 9, 2006
(86) PCT No.: PCT/JP2006/304585

§ 371 Date: Sep. 8, 2008

(51) Int. Cl. G09G 3/28

(52) U.S. Cl. 345/66

(57) ABSTRACT

A plasma arc tube display is fabricated by arranging a plurality of arc tubes having fluorescent substance layers on the inside and filled with a discharge gas, joining a front substrate and a rear substrate having electrodes to both surfaces of these arranged arc tubes, and interconnecting a plurality of plasma arc tube modules having frames facing the rear substrate with the flexible front substrate interposed therebetween to connect the electrodes installed on the front substrate to each other. Since the plasma arc tube modules can be folded, the plasma arc tube display can be easily transported even if it has a large-sized screen.

### TECHNICAL FIELD

The present invention relates to a plasma arc tube display device and, more particularly, relates to a plasma arc tube display device including coupled plural plasma arc tube modules each having arranged plural arc tubes having an electrical discharge space which confines, therein, an electrical discharge gas and a fluorescent member.

### BACKGROUND ART

As structures for realizing large-sized image display devices capable of self light emission, display devices including arranged plural arc tubes which utilize the principle of plasma displays are disclosed in Japanese Unexamined Patent Publication No. Sho 61 (1986)-103187 and Japanese Unexamined Patent Publication No. Hei 11 (1999)-162358.

Each of the arc tubes has a hollow shape with a circular, elliptical, or rectangular cross sectional shape, generally has an MgO layer as a protective layer formed on an inner wall surface of a thin tube with such a shape for protecting a glass surface used in the thin tube from gas electrical discharge, further has a fluorescent layer formed on the MgO layer and, further, confines an electrical discharge gas formed from Ne and Xe gases mixed with each other, for example, within a hollow space thereof. A plurality of such arc tubes fabricated as described above are arranged such that sets of three arc tubes which emit light of respective primary colors of RGB are repeatedly arranged, in order to structure a display device capable of color image display. On front surfaces of these arranged arc tubes which are display surfaces thereof, display electrodes (sustain electrodes X and scan/sustain electrodes Y) are placed in a direction orthogonal to the plasma arc tubes, and address electrodes are provided on back surfaces thereof in a longitudinal direction of the respective plasma arc tubes. The display electrodes are structured by laminating transparent electrodes formed on a transparent resin film for ensuring transmission of emitted light and bus electrodes made of a metal such as copper as conductors, for example, for ensuring conductivity thereof.

Such a display device having the aforementioned structure is capable of realizing a self-light-emission type display with a diagonal distance of, for example, 100 inches, with the arranged plural plasma arc tubes. Further, since the plasma arc tubes are thin tubes, and the MgO layer and the fluorescent layer are formed inside the thin tubes, it is possible to fabricate a large-sized display device with small-scale fabrication equipment for fabricating these plasma arc tubes. This enables fabrication of display devices with lower costs.

As described above, such a display device employing plasma arc tubes has characteristics which other display devices cannot have, but requires attachment of electrode films having electrodes formed on large-area films to the front surfaces and the back surfaces of the arranged plasma arc tubes, in creating a large-area display device having a plurality of arranged plasma arc tubes. Accordingly, fabrication of the large-area electrode films and attachment of the electrode films to the arranged plural plasma arc tubes with high accuracy have induced a problem of increases of costs. Further, in conveying the large-screen display device, there has been a need for a large-sized packaging device, in order to prevent the display surface and the like from experiencing shocks and, furthermore, there has been a problem of difficulty of handling thereof.

Patent Document 1: Japanese Unexamined Patent Publication No. Sho 61 (1986)-103187

Patent Document 2: Japanese Unexamined Patent Publication No. Hei 11 (1999)-162358

### SUMMARY OF THE INVENTION

### Problems to be Solved by the Invention

It is an object of the present invention to overcome an increase of a cost due to fabrication of the aforementioned large-area electrode films and attachment of the electrode films to the arc tubes with high accuracy and also to facilitate conveyance and handling of the large-screen plasma arc tube display device.

### Means for Solving the Problems

In order to overcome the aforementioned problem, a plasma arc tube display device according to one aspect of the present invention is characterized in that it includes plural plasma arc tube modules placed adjacent to one another, each plasma arc tube module including arranged plural plasma arc tubes, a front-surface substrate and a back-surface substrate each having electrodes, which are placed respectively on front surfaces and back surfaces of the arranged plural plasma arc tubes, and a back-surface frame placed on the back-surface substrate at a side which does not face to the plural plasma arc tubes, and coupling portions placed between the respective adjacent plasma arc tube modules, out of the plural plasma arc tube modules, for coupling the plural plasma arc tube modules to one another such that they are pivotable with respect to one another. The coupling portions preferably include folding-back portions of the front-surface substrates which are folded toward the back-surface substrates, in the respective plural plasma arc tube modules, at end portions of the plural plasma arc tube modules which are adjacent to each other, bonding portions for bonding the electrodes on the respective front-surface substrates to one another, and bending portions which can be bent between the folding-back portions and the bonding portions. Further, the plasma arc tubes confine an electrical discharge gas and a fluorescent member.

Further, the respective front-surface substrates can be secured to the respective back-surface frames at the folding-back portions. Also, preferably, chamfering is applied to respective end surfaces of the back-surface frames which are in contact with the front-surface substrates. Furthermore, preferably, the end portions of the respective front-surface substrates in the plasma arc tube module and the other plasma arc tube modules adjacent thereto are partitioned into plural parts, the end portions partitioned into plural parts are folded toward the back-surface substrates, and electrodes on the respective end portions partitioned into the plural parts are bonded to one another through the bonding portions. Also, there are provided fixing portions for fixing the respective back-surface frames in the plasma arc tube module and the other plasma arc tube modules adjacent thereto.

Further, the plasma arc tube display device according to another aspect of the present invention is characterized in that it includes pivot supporting portions which are coupled respectively to the plasma arc tube module and the other plasma arc tube modules adjacent thereto such that the plasma arc tube module and the plasma arc tube modules adjacent thereto are pivotable.

Further, a plasma arc tube display device according to another aspect of the present invention is characterized in that it includes plural arc tube modules each including a front-surface substrate which is provided on front surfaces of plural plasma arc tubes and has plural pairs of electrodes placed thereon in a direction orthogonal to a longitudinal direction of the plasma arc tubes such that the pairs of electrodes are in contact with the plasma arc tubes, a back-surface substrate which is provided on back surfaces of the plural plasma arc tubes and has plural electrodes placed thereon in a direction parallel to the longitudinal direction of the plasma arc tubes such that the electrodes are in contact with the plasma arc tubes, and a back-surface frame placed on the back-surface substrate for supporting the plural plasma arc tubes, a relay driving circuit having driving circuits adapted to apply a voltage to at least one of the pairs of electrodes, the driving circuits being bonded to the electrodes on the front-surface substrates which are placed on the front surfaces of the plural plasma arc tubes and are folded toward the back-surface substrates at end portions thereof and to the electrodes on the front-surface substrates which are placed on front surfaces of other plasma arc modules adjacent to the plasma arc tube modules and are folded toward the back-surface substrates at the end portions, and coupling portions for coupling the plasma arc tube module to the other plasma arc tube modules adjacent thereto.

In this case, the aforementioned coupling portions can have folding-back portions of the front-surface substrates which are folded toward the back-surface substrates, in the respective plural plasma arc tube modules, at the end portions of the plural plasma arc tube modules which are adjacent to each other, bonding portions for bonding the electrodes on the respective front-surface substrates to one another, and bending portions which can be bent between the folding-back portions and the bonding portions.

A plasma arc tube display device according to another aspect of the present invention is characterized in that it includes a front-surface substrate which is provided on front surfaces of plural plasma arc tubes and has plural pairs of electrodes placed thereon in a direction orthogonal to a longitudinal direction of the plasma arc tubes such that the pairs of electrodes are in contact with the plasma arc tubes, each pair of electrodes being constituted by a pair of a sustain electrode X and a scan/sustain electrode Y; a back-surface substrate which is provided on back surfaces of the plural plasma arc tubes and has plural address electrodes placed thereon in a direction parallel to the longitudinal direction of the plasma arc tubes such that the address electrodes are in contact with the plasma arc tubes; a driving unit which performs processing on signals from external devices, applies driving voltages to the pairs of electrodes and the address electrodes, applies a driving voltage to ones of the pairs of electrodes, in order to select cells which are defined by the pairs of electrodes and the address electrodes and are associated with light emission areas of fluorescent members, in response to the signals, and applies a driving voltage to the pairs of electrodes for causing the fluorescent members to emit light; a back-surface frame which is placed on the back-surface substrate in a plasma arc tube module for supporting the plasma arc tube module; bonding portions for bonding the electrodes on the front-surface substrate which is placed on the front surface of the plasma arc tube module and is folded toward the back-surface substrate at end portions and the electrodes on the front-surface substrates which are placed on front surfaces of other plasma arc tube modules adjacent to the plasma arc tube module and are folded toward the back-surface substrates at end portions to each other; and bending portions which can be bent between the bonding portions and the end portions of the respective front-surface substrates in the plasma arc tube module and the other plasma arc tube modules adjacent thereto.

In this case, preferably, there are provided fixing portions for securing the respective back-surface frames in the plasma arc tube module and the other plasma arc tube modules adjacent thereto, and the fixing portions have pivot supporting portions which are coupled respectively to the plasma arc tube module and the other plasma arc tube modules adjacent thereto such that the plasma arc tube module and the plasma arc tube modules adjacent thereto are pivotable.

### EFFECTS OF THE INVENTION

Since there are provided plural plasma arc tube modules including arranged plural plasma arc tubes, front-surface substrates having pairs of display electrodes provided on the front surfaces of the arranged plasma arc tubes and back-surface substrates having address electrodes provided on the back surfaces thereof, the respective plasma arc tube modules are connected to one another through the front-surface substrates having flexibility for relaying the electrodes provided on the front-surface substrates, it is possible to realize a plasma arc tube display device which enables reducing areas of the front-surface substrates and the back-surface substrates, folding up the plasma arc tube modules and cost reduction and also facilitates conveyance thereof even if it has a large sized screen.

### BRIEF DESCRIPTION OF THE DRAWINGS

FIG. 1 is a view illustrating a general outline of a plasma arc tube display device.

FIG. 2 is a schematic view illustrating main parts of the plasma arc tube display device.

FIG. 3 is a schematic view illustrating main parts of connections between plasma arc tube modules.

FIG. 4 is a schematic view of an electrode relay board in FIG. 3.

FIG. 5 is a view illustrating another example of the electrode relay board illustrated in FIG. 4.

FIG. 6 is a schematic view of a back-surface frame.

FIG. 7 is a schematic view illustrating another example of a first embodiment.

FIG. 8 is a schematic view illustrating a second embodiment.

FIG. 9 is a schematic view illustrating another example of the second embodiment.

FIG. 10 is a schematic view illustrating a state where the plasma arc tube modules are folded up.

FIG. 11 is a schematic view illustrating an example where four plasma arc tube modules are employed.

FIG. 12 is a schematic view illustrating a state where the plasma arc tube modules are folded up.

FIG. 13 is a view illustrating exemplary connections between the plasma arc tube display device and peripheral circuits.

FIG. 14 is a schematic view illustrating the exemplary connections illustrated in FIG. 13.

### BEST MODE FOR CARRYING OUT THE INVENTION

Hereinafter, preferred embodiments for carrying out the present invention will be described. In the present embodiments, there will be mainly described a case where arc tubes have a substantially rectangular cross sectional shape (with a longer side equal to 1 mm, a shorter side equal to 0.5 mm, and a thickness equal to 100 micrometers), but the cross sectional shape can be another shape such as a circular shape or an elliptical shape. Further, even in a case of rectangular cross sectional areas, dimensions are not limited to the aforementioned dimensions.

### First Embodiment

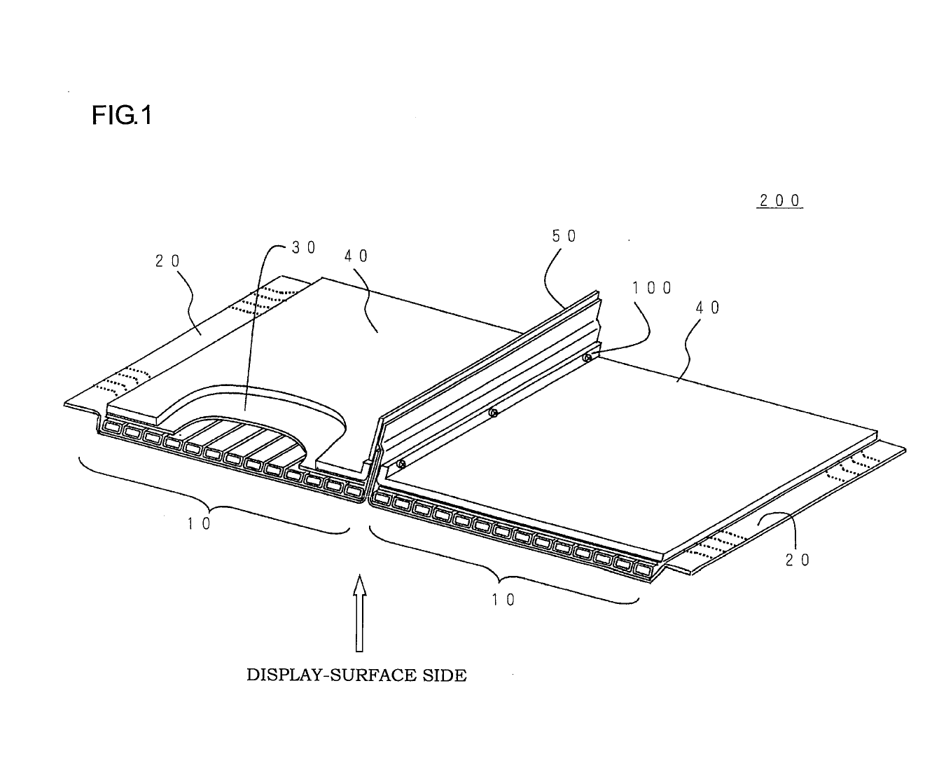

FIG. 1 illustrates a schematic view illustrating a plasma arc tube display device 200 according to the present invention which employs two plasma arc tube modules 10, when this plasma arc tube display device 200 is viewed at a back surface thereof. Back-surface frames 40 provided on back-surface substrates 30 in the respective plasma arc tube modules 10 are secured through fixture screws 100 (three screws in the figure), and pairs of display electrodes (which will be described later in detail) provided on front-surface substrates 20 in the respective plasma arc tube modules 10 are electrically connected to each other through an electrode relay board 50. Further, the back-surface substrates 30 also have redundant portions protruding from the back-surface frames 40, in order to be connected to circuits which are not illustrated, similarly to the front-surface substrates 20, but the redundant portions are not illustrated, for clarification of illustration of main parts of the present invention.

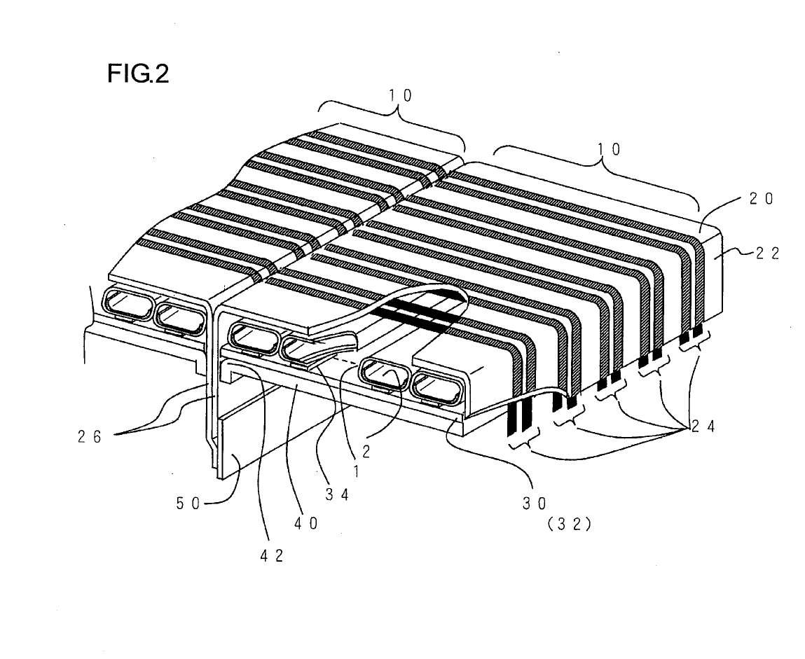

FIG. 2 is a perspective view illustrating main parts of the plasma arc tube modules 10 used in the plasma arc tube display device according to the present invention, illustrating the vicinity of the plasma arc tube modules 10 which are adjacent to each other. The plasma arc tube display device 200 employs the plural plasma arc tube modules 10 to constitute a display screen.

Plasma arc tubes 1 constituting the plasma arc tube modules 10 have a rectangular-shaped cross section, have a protective layer (for example, an MgO layer, which is not illustrated) formed on tubular walls thereof and further have a fluorescent layer 2 placed thereon. Further, an electrical discharge gas (for example, a gas formed from Xe gas and Ne gas which are mixed with each other, which is not illustrated) is enclosed therein, and the plasma arc tubes are sealed at opposite end portions. A plurality of such plasma arc tubes 1 are arranged, and the front-surface substrates 20 are attached to front surfaces of the plasma arc tubes 1 and the back-surface substrates 30 are attached to back surfaces of the plasma arc tubes 1, through a transparent adhesive member, preferably an epoxy resin or a photo-curing resin. Pairs of display electrodes 24 are formed on base films 22 in the front-surface substrate 20 at the surfaces contacting with the plasma arc tubes 1. The base films 22 are made of transparent films for facilitating transmission of light emitted from the plasma arc tubes 1 therethrough and, in the first embodiment, are made of films with a thickness of 120 micrometers which are made of poly ethylene terephthalate (PET). A material of the base films 22 is not limited to PET, and can be any material having flexibility for facilitating attachment to the plasma arc tubes 1, having transparency and also enabling formation of transparent electrodes (for example, ITO films and NESA films), metal electrodes, metal mesh-type electrodes and the like which constitute the pairs of display electrodes 24 formed on the base films 22. Further, the thickness thereof is not limited to 120 micrometers.

Address electrodes 34 are formed on base films 32 in the back-surface substrates 30. The address electrodes 34 are placed through copper plating to have a width of 200 micrometers and a thickness of 20 micrometers, such that they are in contact with lower portions of the plasma arc tubes 1 along a longitudinal direction of the respective plasma arc tubes 1. Also, the address electrodes 34 can be formed from a conductive paste through print processing, as well as through plating. It is also possible to employ a method for forming address electrodes 34 with a desired shape, by applying etching to a metal layer such as a copper layer attached to the base films 32.

The fluorescent layers 2 formed in the plasma arc tubes 1 are made of fluorescent members corresponding to colors of light emitted from the plasma arc tubes 1. For example, the plasma arc tube 1 which emits red light, the plasma arc tube 1 which emits green light, and the plasma arc tube 1 which emits blue light are arranged, in an order mentioned above.

The back-surface frame 40 is mounted to one surface of the back-surface substrate 30. The back-surface frame 40 and the back-surface substrate 30 can be mounted to each other by attaching them together on the entire surfaces or by partially attaching them to each other. Further, a curved portion 42 is provided or chamfering is applied to an end portion of the back-surface frame 40 near a portion of the plasma arc tube module 10 which is in contact with the adjacent plasma arc tube module 10, so that the back-surface frame 40 is processed into an L shape.

The aforementioned front-surface substrates 20 are folded, at folding-back portions 26, toward the back-surface substrates 30, near the adjacent plasma arc tube module 10, and the electrode relay board 50 establishes electrical connection between the pairs of display electrodes 24 in the respective plasma arc tube modules 10 adjacent to each other.

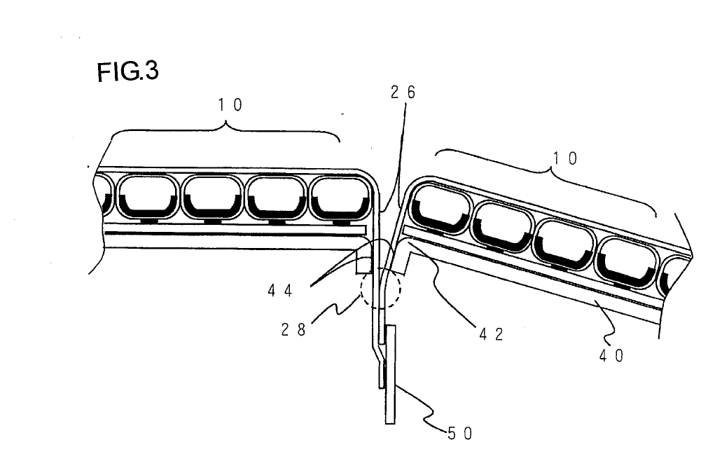

As described above, the plasma arc tube modules 10 are connected to each other through the electrode relay board 50, and the base films 22 in the front-surface substrates 20 are formed from PET or the like which has flexibility, which allows the plasma arc tube modules 10 to be folded about the vicinity of the electrode relay board 50, as illustrated in FIG. 3. More specifically, end portions of the respective plasma arc tube modules 10 are folded at the folding-back portions 26 toward the back-surface substrates 30 and are secured to the frames, near the curved portions 42 of the back-surface frames 40, through an epoxy resin or the like, to form fixing portions 44. The respective front-surface substrates 20 are not secured to other members, up to the vicinity of the electrode relay board 50 beyond the fixed portions 44, thereby forming bending portions 28 which can be bent due to flexibility of the base films 22.

As described above, the plasma arc tube modules 10 are connected to each other, through the base films 22 having flexibility, to form coupling portions therebetween, which allows the plasma arc tube modules 10 to be folded with respect to each other, as illustrated in FIG. 3.

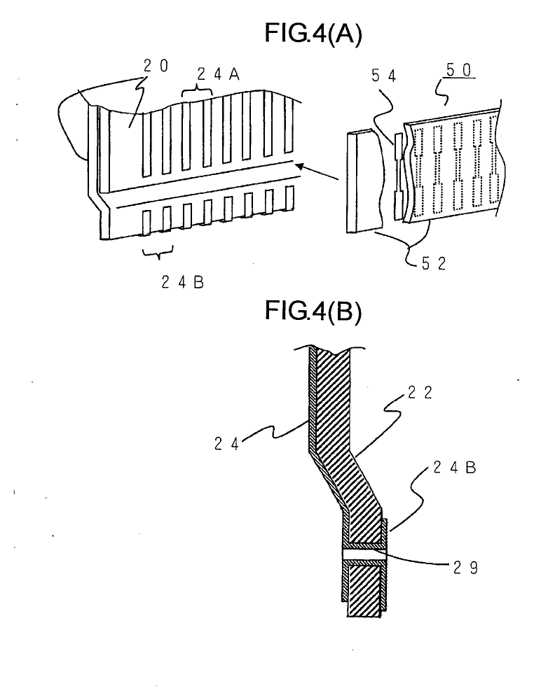

Next, with reference to FIG. 4A, there will be described, in detail, the vicinity of the electrode relay board 50. The electrode relay board 50 is formed from a substrate 52 made of PET or epoxy resin and a conductive relay pattern 54 formed on one surface of the substrate 52, and this relay pattern 54 electrically connects pairs of display electrodes 24A on one of the plasma arc tube modules 10 to pairs of display electrodes 24B on the other plasma arc tube module 10. The pairs of display electrodes 24B are formed from a conductive pattern extending from the back surface of the front-surface substrate 20 to the front surface thereof through an end portion of the base film 22 in the front-substrate substrate 20, as illustrated in FIG. 4A. The pairs of display electrodes 24A and 24B and the relay pattern 54 on the electrode relay board 50 are coupled to each other, through thermo compression bonding, for example.

A structure of the pairs of display electrodes 24B is such that the display electrodes 24 and the display electrodes 24B are connected to each other via a through hole penetrating through the base film 22, and the pairs of display electrodes 24A and the pairs of display electrodes 24B on the respective front-surface substrates 20 are electrically connected to each other through the electrode relay board 50. The pairs of display electrodes 24A can also be provided with a through hole, and the pairs of display electrodes 24A and 24B on the respective front-surface substrates 20 can be directly electrically connected to each other, through thermo compression bonding, without using the electrode replay board 50.

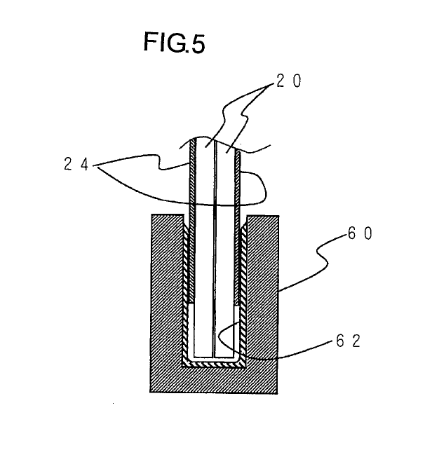

Further, FIG. 5 illustrates a structure of another connection of the pairs of display electrodes 24. FIG. 5 illustrates a relaying method using a connector 60, instead of the electrode relay board 50, wherein an electrically-conductive conductor 62 for connecting the pairs of display electrodes 24 in the respective plasma arc tube modules 10 to each other is provided on an inner surface of the connector 60. This conductor 62 is in contact with the pairs of display electrodes 24 on the respective front-surface substrates 20, thereby enabling establishing electrical conduction between the corresponding pairs of display electrodes 24 on the respective adjacent front-surface substrates 20. This method offers an advantage of eliminating necessity of providing pairs of display electrodes 24 on the opposite surfaces of the front-surface substrates 20. Further, it is also possible to employ a method of connecting the respective electrodes to one another through conductors, a method of connecting them through a flexible print board, and the like, in order to establish electrical conduction between the pairs of display electrodes 24.

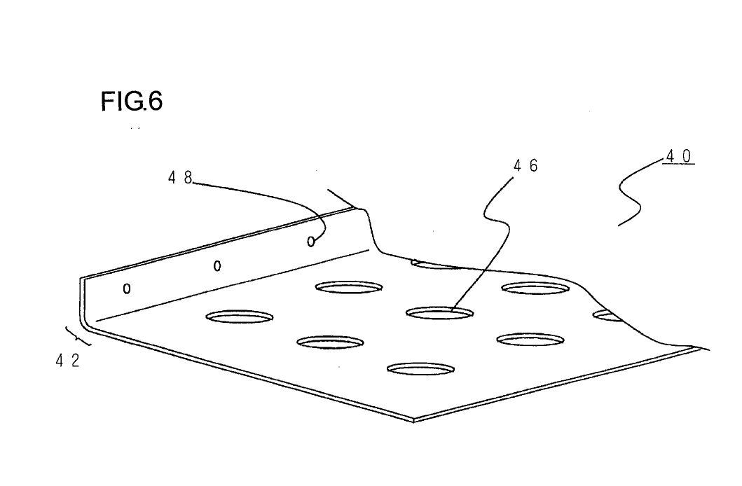

Next, with reference to FIG. 6, the back-surface frames 40 will be described in detail. A material of the back-surface frames 40 may be any hard material, but is preferably an aluminum material since it is lightweight, has excellent heat conductivity and excellent workability. FIG. 6 is a main-part schematic view of a back-surface frame made of an aluminum plate, illustrating the vicinity of the curved portion 42 of FIG. 2. There are provided vent holes 46, in order to reduce the weight of the back-surface frame 40 and improve air permeability thereof, at a portion in contact with the back-surface substrate 30 in the plasma arc tube module 10, and there are further provided holes 48 in the L-shaped portion near the curved portion 42. The holes 48 are for securing, through screws or the like, the L-shaped portions of the opposing back-surface frames 40 in the adjacent plasma arc tube modules 10 to each other.

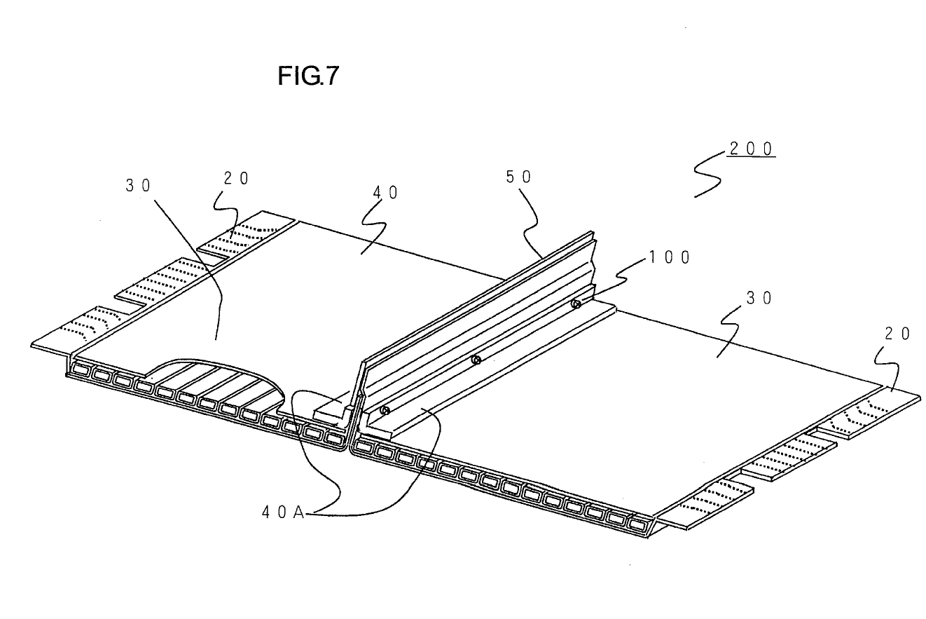

FIG. 7 illustrates another example of the plasma arc tube display device 200 according to the aforementioned first embodiment. The plasma arc tube display device 200 illustrated in FIG. 7 employs back-surface frames 40A, instead of the back-surface frames 40 illustrated in FIG. 1. The back-surface frames 40A are structured to be placed only near a connection portion between the plasma arc tube modules 10 and offer an advantage of reduction of the weight of the plasma arc tube display device 200.

In the plasma arc tube display device 200 according to the first embodiment, the respective front-surface substrates 20 are folded toward the back-surface substrates 30, between the plasma arc tube modules 10, and folded portions are provided with the bending portions 28 at which the respective front-surface substrates 20 can be bent. Accordingly, even if the plasma arc tube display device 200 has a large-sized display screen, it is possible to fold up the plasma arc tube modules 10, thereby facilitating handling thereof, during conveyance. Further, it is possible to create the individual small-sized plasma arc tube modules 10 and then assemble the plural plasma arc tube modules 10 to create the plasma arc tube display devices 200, which enables reduction of the sizes of the front-surface substrates 20 and the back-surface substrates 30 and also enables replacement of only plasma arc tube modules 10 which have been flawed, thereby offering an advantage of increase of a fabrication yield.

### Second Embodiment

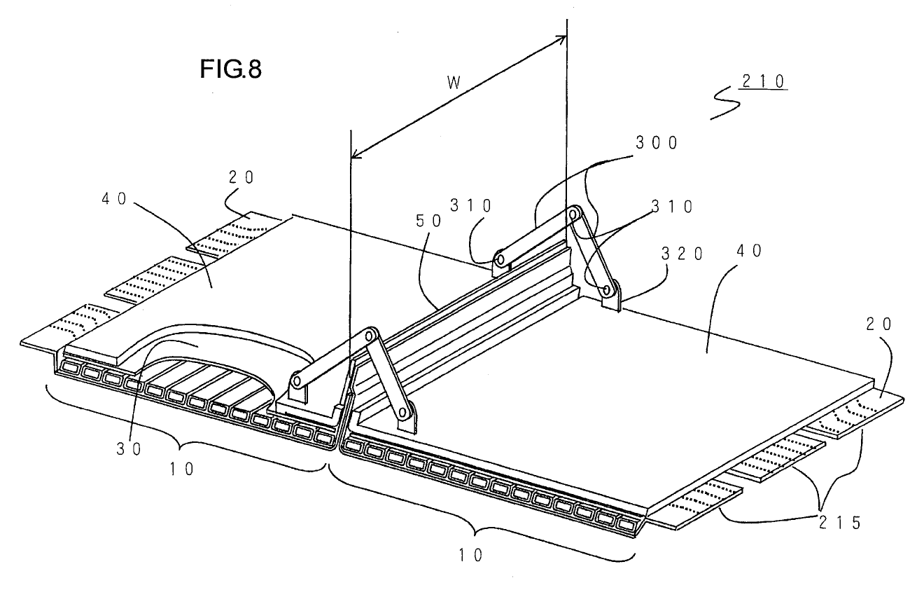

Next, a second embodiment will be described with reference to FIG. 8. In the second embodiment, components having the same functions as those in the first embodiment are designated by the same reference symbols. The second embodiment is different from the first embodiment, in that a plasma arc tube display device 210 according to the second embodiment has pivot supporting portions constituted by fixing portions 320 secured to back-surface frames 40 and arms 300 mounted to the fixing portions 320 pivotably about shafts 310. The two arms 300 are allowed to pivot about the respective shafts 310, thereby allowing the plasma arc tube modules 10 to pivot with respect to each other. Accordingly, the plasma arc tube modules 10 are connected to each other through connection means which have the arms 300 and are capable of pivotably supporting them, which can maintain a positional relationship between the plasma arc tube modules 10 more firmly than in the plasma arc tube display device 200 according to the first embodiment which is adapted such that the plasma arc tube modules 10 are connected to each other through only the electrode relay board 50. This can reduce external forces applied to the electrode relay board 50, thereby improving durability of the plasma arc tube display device 210 during conveyance.

Further, it is preferable to place the aforementioned two connection means employing the arms 300 at positions outside of a width W of the electrode relay board 50. By placing the connection means in this manner, the connection means and the electrode relay board 50 are prevented from coming into contact with each other, when the plasma arc tube modules 10 are folded up.

Further, the plasma arc tube display device 210 has electrode deriving portions 215 for connecting the front-surface substrates 20 to circuits and the like which are not illustrated, wherein the electrode deriving portions 215 are shaped to be partitioned into plural parts. This shape is adaptable to the front-surface substrates 20 according to the first embodiment, and the partitioned electrode deriving portions 215 offer an advantage of enabling mounting the respective parts individually, thereby alleviating deformation of the front-surface substrates 215.

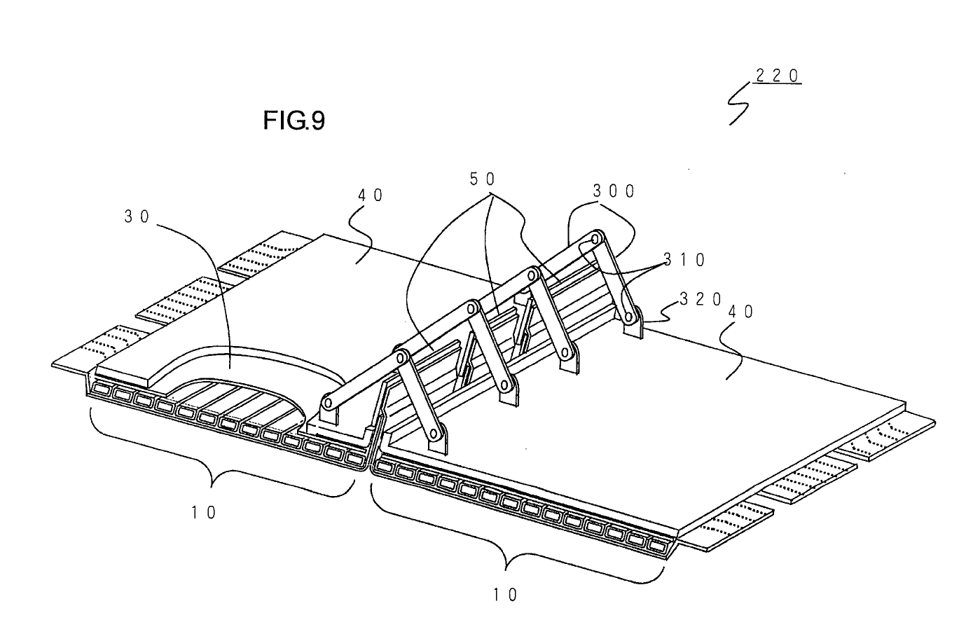

FIG. 9 illustrates another example of the second embodiment. A plasma arc tube display device 220 illustrated in FIG. 9 is the same as the plasma arc tube display device 210 in that arms 300 are mounted to fixing portions 320 secured to the back-surface frames 40 pivotably about shafts 310, but is different from the plasma arc tube display device 210 in that the number of the connection means employing the arms is increased to 4 and, also, is different therefrom in that the number of the electrode relay boards 50 used therein is more than one (3 electrode relay boards, in the figure). Since the plasma arc tube display device 220 has an increased number of the connection means, it is possible to further reduce external forces applied to the electrode relay boards 50, thereby improving durability of the plasma arc tube display device 220 during conveyance. Further, since the plural electrode relay boards 50 are employed, it is possible to facilitate positioning of the relay patterns 54 (see FIG. 4A on the electrode relay boards 50 and the pairs of display electrodes 24 on the front-surface substrates 20, thereby improving efficiency of mounting operations.

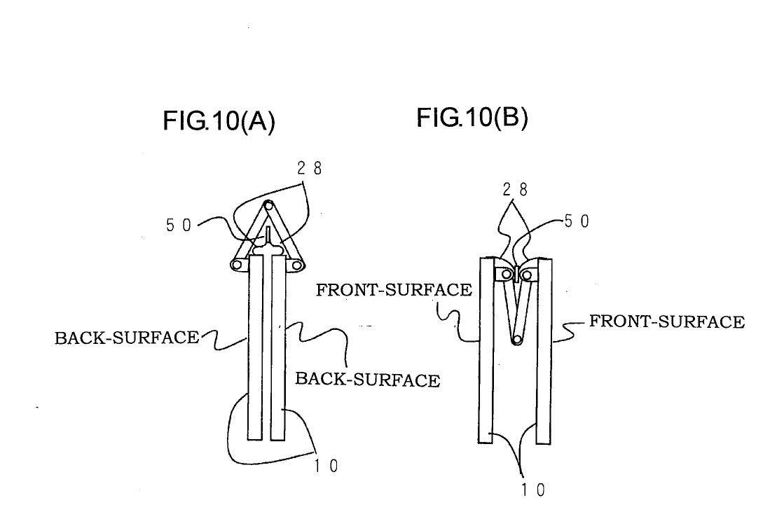

FIG. 10A and FIG. 10B illustrate the shape of the plasma arc tube display device 210 or 220 according to the aforementioned second embodiment, when it is folded up. FIG. 10A illustrates a state where it is folded up such that the back surfaces of the plasma arc tube modules 10 are faced outwardly, and FIG. 10B illustrates a state where it is folded up such that the front surfaces of the plasma arc tube modules 10 are faced outwardly. Since the connection means employing the bending portions 28 are employed between the respective plasma arc tube modules 10, it is possible to fold them up as illustrated in the figures.

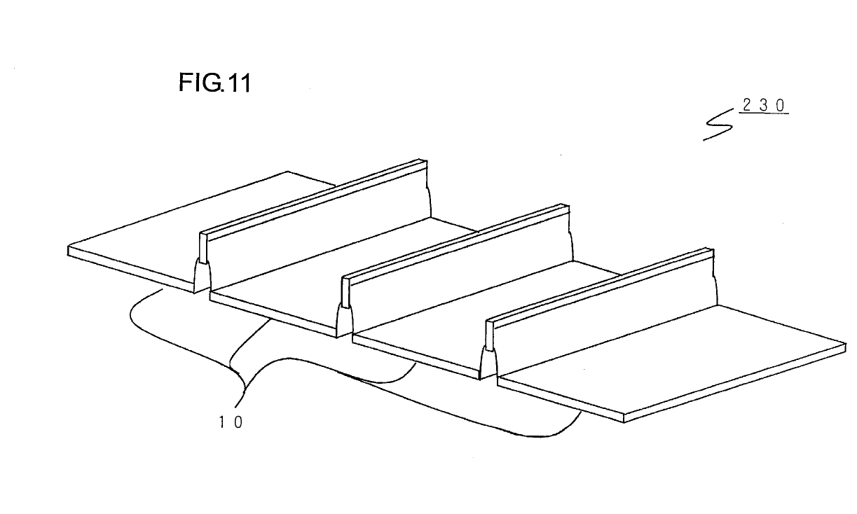

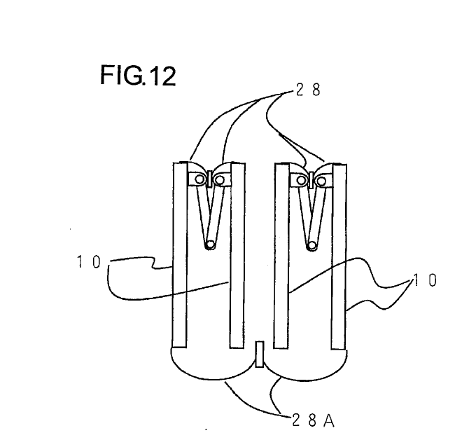

While, in the first and second embodiments, there have been described a case where the two plasma arc tube modules 10 are used, FIG. 11 illustrates an example of a plasma arc tube display device 230 employing four plasma arc tube modules 10. The plasma arc tube display device 230 employs connection means employing arms as in the second embodiment, but they are not illustrated in FIG. 11 for clarification of illustration in the figure. Further, FIG. 12 illustrates a state where the plasma arc tube display device 230 is folded up. FIG. 12 illustrates that the plasma arc tube display device 230 according to the present invention can be folded up, even though four plasma arc tube modules 10 are used, by elongating the bending portions 28 between the plasma arc tube modules 10 which form outermost surfaces in the folded-up state.

### Third Embodiment

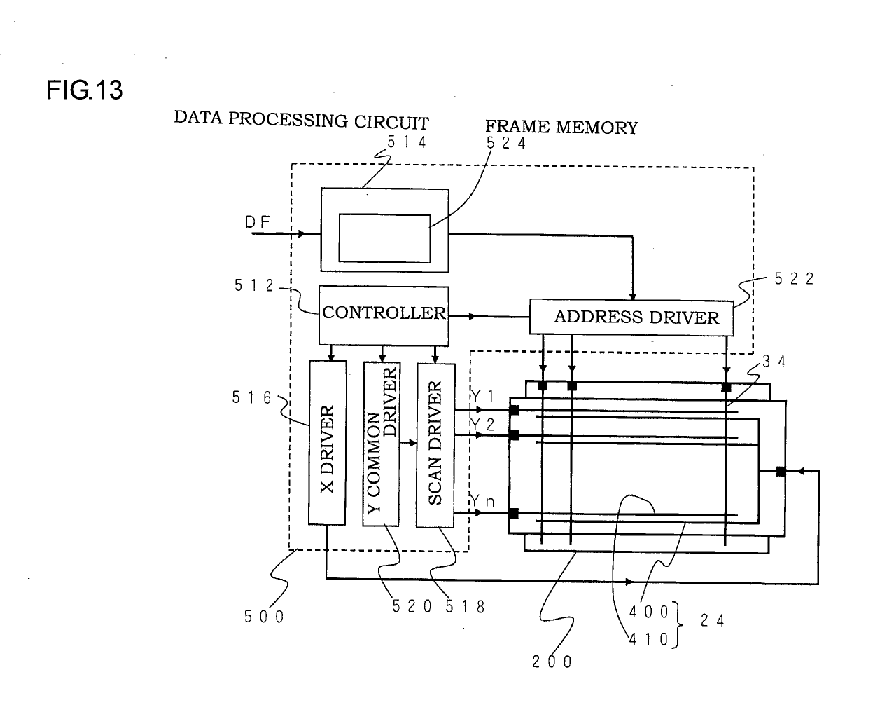

FIG. 13 is a view illustrating connection between the plasma arc tube display device 200, 210, 220 or 230 described in the first and second embodiments and peripheral circuits. FIG. 13 illustrates connection between the plasma arc tube display device 200 and the peripheral circuits, but the plasma arc tube display devices 210, 220 and 230 can be employed, instead of the plasma arc tube display device 200.

A driving unit 500 is connected to the plasma arc tube display device 200. In the present embodiment, the pairs of display electrodes 24 extend in the direction of rows in the display screen, and each pair of display electrodes 24 is constituted by a pair of a scan/sustain electrode Y410 and a sustain electrode X400. Areas at intersections of the pairs of display electrodes 24 and the address electrodes 34 are referred to as cells. In selecting cells to be caused to emit light through electrical discharge between the pairs of display electrodes 24, out of the cells, the scan/sustain electrodes Y410 are used as scan electrodes for use in selecting cells on a row-by-row basis. The address electrodes 34 extend in the direction of columns and are used as electrodes for selecting cells on a column-by-column basis. The driving unit 500 includes a controller 512, a data processing circuit 514, an X driver 516, a scan driver 518, a Y common driver 520, an address driver 522, a power supply circuit which is not illustrated, and the like. An externals device such as a TV tuner or a computer inputs, to the driving unit 500, field data DF indicative of luminance levels (tone levels) (luminance levels for respective colors of R, G and B in a case of color display), on a pixel-by-pixel basis, along with various types of synchronization signals. The field data DF is temporarily stored in a frame memory 524 in the data processing circuit 514, then is subjected to processing required for tone display, then is stored in the frame memory 524 and is transferred to an address driver 222 at proper timing.

The X driver 516 applies a driving voltage to all the sustain electrodes X400. The scan driver 518 applies a driving voltage to the respective scan/sustain electrodes Y410 individually, in selecting cells. The Y common driver 520 applies a driving voltage to all the scan/sustain electrodes Y410 concurrently, in maintaining lighting of the selected cells.

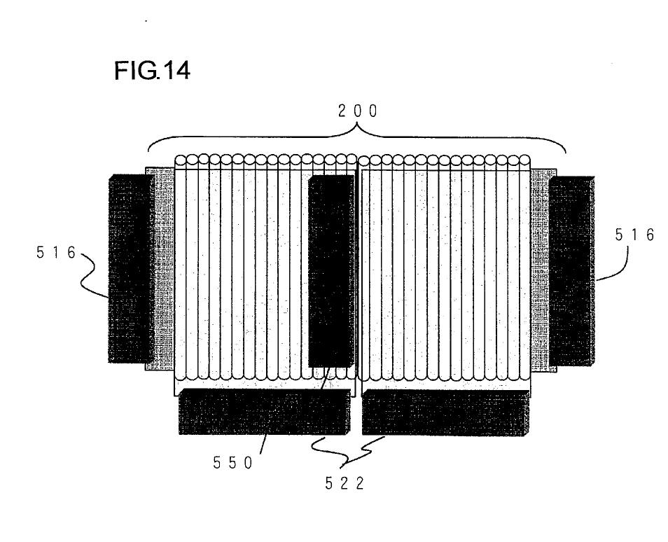

FIG. 14 schematically illustrates a positional relationship among the address driver 522, the X driver 516, the scan driver 518 and the Y common driver 520 for driving the scan/sustain electrodes Y410 (the scan driver 518 and the Y common driver 520 are comprehensively referred to as a scan/sustain electrode Y driver 550) which have been described above, and the plasma arc tube display device 200. FIG. 14 is a view illustrating the plasma arc tube display device 200 at the back surface thereof, wherein the same components as those in the first and second embodiments are designated by the same reference symbols. In the plasma arc tube display device 200 illustrated in FIG. 14, the scan/sustain electrode Y driver 550 is placed on the electrode relay board 50 used in the first and second embodiments. Since the scan/sustain electrode Y driver 550 is placed at the center portion of the plasma arc tube display device 200 as described above, the scan/sustain electrodes Y410 practically has a length half that in a case where the scan/sustain electrode Y driver 550 is placed on the front-surface substrates 20, thereby reducing an influence of voltage drop across the scan/sustain electrodes Y410.

### INDUSTRIAL APPLICABILITY

Plasma arc tube modules including arranged plural arc tubes having fluorescent layers placed inside thereof, front-surface substrates and back-surface substrates which are provided with electrodes and are attached to opposite surfaces of these arranged arc tubes, and frames provided on the back-surface substrates are connected to each other through the front-surface substrates having flexibility for relaying the electrodes provided on the front-surface substrates. This can realize a plasma arc tube display device which enables folding up plasma arc tube modules, thereby facilitating conveyance even if it has a large-sized screen.

### DESCRIPTION OF REFERENCE SYMBOLS

1: Plasma arc tube
2: Fluorescent layer
10: Plasma arc tube module
20: Front-surface substrate
24: Pairs of display electrodes
26: Folded portion
28: Bending portion
30: Back-surface substrate
34: Address electrode
40: Back-surface frame
50: Electrode relay board
200: Plasma arc tube display device

1. A plasma arc tube display device comprising:
plural plasma arc tube modules placed adjacent to one another, each plasma arc tube module comprising arranged plural plasma arc tubes, a front-surface substrate and a back-surface substrate each having electrodes, which are placed respectively on front surfaces and back surfaces of the arranged plural plasma arc tubes, and a back-surface frame placed on the back-surface substrate at a side which does not face the plural plasma arc tubes, and
coupling portions placed between the plural plasma arc tube modules, for coupling the plural plasma arc tube modules to one another such that they are pivotable with respect to one another.

2. The plasma arc tube display device according to claim 1, wherein
the coupling portions comprise
folding-back portions of the front-surface substrates which are folded toward the back-surface substrates, in the respective plural plasma arc tube modules, at end portions of the plural plasma arc tube modules which are adjacent to each other,
bonding portions for bonding the electrodes on the respective front-surface substrates to one another, and
bending portions which can be bent between the folding-back portions and the bonding portions.

3. The plasma arc tube display device according to claim 2, wherein
the respective front-surface substrates are secured to the respective back-surface frames at the folding-back portions.

4. The plasma arc tube display device according to claim 1, wherein
chamfering is applied to an end surface of the back-surface frame which is in contact with the front-surface substrate.

5. The plasma arc tube display device according to claim 1, wherein
end portions of the respective front-surface substrates in the plasma arc tube module and the other plasma arc tube modules adjacent thereto are partitioned into plural parts, the end portions partitioned into plural parts are folded toward the back-surface substrates, and electrodes on the respective end portions partitioned into the plural parts are bonded to one another through the bonding portions.

6. The plasma arc tube display device according to claim 1, further comprising fixing portions for fixing the respective back-surface frames in the plasma arc tube module and the other plasma arc tube modules adjacent thereto.

7. The plasma arc tube display device according to claim 6, wherein
the fixing portions have pivot supporting portions which are coupled respectively to the plasma arc tube module and the other plasma arc tube modules adjacent thereto such that the plasma arc tube module and the plasma arc tube modules adjacent thereto are pivotable.

8. The plasma arc tube display device according to claim 7, wherein
the fixing portions have variable portions which extend and contract distances among the pivot supporting portions and the plasma arc tube module and the other plasma arc tube modules adjacent thereto, thereby realizing a structure which enables folding up the plasma arc tube module and the other plasma arc tube modules adjacent thereto.

9. The plasma arc tube display device according to claim 8, wherein
the fixing portions have a structure for folding up the plasma arc tube module and the other plasma arc tube modules adjacent thereto, such that respective front surfaces of the plasma arc tube module and the other plasma arc tube modules adjacent thereto are faced inwardly.

10. A plasma arc tube display device comprising:
plural arc tube modules each comprising a front-surface substrate which is provided on front surfaces of plural plasma arc tubes and has plural pairs of electrodes placed thereon in a direction orthogonal to a longitudinal direction of the plasma arc tubes such that the pairs of electrodes are in contact with the plasma arc tubes, a back-surface substrate which is provided on back surfaces of the plural plasma arc tubes and has plural electrodes placed thereon in a direction parallel to the longitudinal direction of the plasma arc tubes such that the electrodes are in contact with the plasma arc tubes, and a back-surface frame placed on the back-surface substrate for supporting the plural plasma arc tubes,
a relay driving circuit having driving circuits adapted to apply a voltage to at least one of the pairs of electrodes, the driving circuits being bonded to the electrodes on the front-surface substrates which are placed on the front surfaces of the plural plasma arc tubes and are folded toward the back-surface substrates at end portions and to the electrodes on the front-surface substrates which are placed on front surfaces of other plasma arc modules adjacent to the plasma arc tube module and are folded toward the back-surface substrates at the end portions, and
coupling portions for coupling the plasma arc tube modules to the other plasma arc tube module adjacent thereto.

11. The plasma arc tube display device according to claim 10, wherein
the coupling portions have folding-back portions of the front-surface substrates which are folded toward the back-surface substrates, in the respective plural plasma arc tube modules, at end portions of the plural plasma arc tube modules which are adjacent to each other,
bonding portions for bonding the electrodes on the respective front-surface substrates to one another, and
bending portions which can be bent between the folding-back portions and the bonding portions.

12. The plasma arc tube display device according to claim 10, further comprising fixing portions for fixing the respective back-surface frames in the plasma arc tube module and the other plasma arc tube modules adjacent thereto.

13. A plasma arc tube display device comprising:
a front-surface substrate which is provided on front surfaces of plural plasma arc tubes and has plural pairs of electrodes placed thereon in a direction orthogonal to a longitudinal direction of the plasma arc tubes such that the pairs of electrodes are in contact with the plasma arc tubes, each of the pairs of electrodes being constituted by a pair of a sustain electrode X and a scan/sustain electrode Y;
a back-surface substrate which is provided on back surfaces of the plural plasma arc tubes and has plural address electrodes placed thereon in a direction parallel to the longitudinal direction of the plasma arc tubes such that the address electrodes are in contact with the plasma arc tubes;
a driving unit which performs processing on signals from external devices, applies driving voltages to the pairs of electrodes and the address electrodes, applies a driving voltage to ones of the pairs of electrodes, in order to select cells which are defined by the pairs of electrodes and the address electrodes and are associated with light emission areas of fluorescent members, in response to the signals, and applies a driving voltage to the pairs of electrodes for causing the fluorescent members to emit light;
a back-surface frame which is placed on the back-surface substrate in a plasma arc tube module for supporting the plasma arc tube module;
bonding portions for bonding the electrodes on the front-surface substrate which is placed on a front surface of the plasma arc tube module and is folded toward the back-surface substrate at end portions thereof and the electrodes on the front-surface substrates which are placed on front surfaces of other plasma arc tube modules adjacent to the plasma arc tube module and are folded toward the back-surface substrates at end portions to each other; and
bending portions which can be bent between the bonding portions and the end portions of the respective front-surface substrates in the plasma arc tube module and the other plasma arc tube modules adjacent thereto.

14. The plasma arc tube display device according to claim 13, further comprising fixing portions for securing the respective back-surface frames in the plasma arc tube module and the other plasma arc tube modules adjacent thereto,
wherein the fixing portions have pivot supporting portions which are coupled respectively to the plasma arc tube module and the other plasma arc tube modules adjacent thereto such that the plasma arc tube module and the plasma arc tube modules adjacent thereto are pivotable.
